(19) United States
(12) Patent Application Publication
(10) Pub. No.: US 2024/0229948 A9
(43) Pub. Date: Jul. 11, 2024

(54) ANTI-BACK-TRANSFER INTAKE STRUCTURE FOR ROTATING DETONATION COMBUSTION CHAMBER

(71) Applicant: PLA AIR FORCE ENGINEERING UNIVERSITY, Xi’an (CN)

(72) Inventors: Feilong SONG, Xi’an (CN); Yun WU, Xi’an (CN); Xin CHEN, Xi’an (CN); Min JIA, Xi’an (CN); Huimin SONG, Xi’an (CN); Shanguang GUO, Xi’an (CN); Zhao YANG, Xi’an (CN); Jiaojiao WANG, Xi’an (CN)

(21) Appl. No.: 18/400,324

(22) Filed: Dec. 29, 2023

Related U.S. Application Data
(63) Continuation-in-part of application No. 17/848,036, filed on Jun. 23, 2022.

(30) Foreign Application Priority Data
Jun. 26, 2021 (CN) 202110715244.8

(51) Int. Cl. F16K 15/00; F23R 7/00

(52) U.S. Cl. CPC F16K 15/00; F23R 7/00

(57) ABSTRACT

The application relates to an anti-back-transfer intake structure of a rotating detonation combustion chamber including a Tesla valve communicating with the rotating detonation combustion chamber and arranged at an inlet of the rotating detonation combustion chamber. The Tesla valve includes a casing and a flow passage, the casing is coaxially connected with an outer wall of the rotating detonation combustion chamber, the flow passage is arranged in the casing, and the flow passage has an inlet end for introducing air, and an outlet end connected with an annular passage of the rotating detonation combustion chamber.

### CROSS-REFERENCE TO RELATED APPLICATION

The present application is a continuation-in-part of U.S. application Ser. No. 17/848,036, filed on Jun. 23, 2022, which claims the priority benefits of China application No. 202110715244.8, filed on Jun. 26, 2021. The entireties of U.S. application Ser. No. 17/848,036 and China application No. 202110715244.8 are hereby incorporated by reference herein and made a part of this specification.

### TECHNICAL FIELD

The application relates to the field of aeroengines, and in particular, to an anti-back-transfer intake structure for a rotating detonation combustion chamber.

### BACKGROUND ART

Detonation combustion is realized by compressing the explosive mixture with the leading fundamental wave to produce a high-speed chemical reaction. Because detonation combustion has the advantages of high heat release intensity per unit time, self pressurization, high combustion efficiency and low pollutant emission, the propulsion technology based on detonation combustion is an important development trend of space technology in the future. A rotating detonation combustion chamber is an annular combustion chamber using detonation combustion. The fuel is supplied by multiple nozzles at the head of the combustion chamber.

As shown in FIG. 1, in a related technology, an intake structure for a rotating detonation combustion chamber includes an air inlet end 2 communicating with the combustion chamber body 1 and arranged at the inlet of the combustion chamber body 1. The air inlet end 2 includes a coaxially sleeved inner wall 21 and an outer wall 22. Between the inner wall 21 and the outer wall 22, there is an air inlet passage 23 for fuel and air to enter the combustion chamber body 1. The air inlet passage 23 includes a straight passage 231 and an enlarged passage 232. One end of the straight passage 231 is connected with an air inlet end, the other end is connected with the gradually enlarged passage 232, and the other end of the enlarged passage 232 is connected with the combustion chamber body 1. Therefore, a converging-enlarging inlet structure is formed.

In the above related technology, it is found that there is back transfer of pressure in the existing rotating detonation combustion chamber, resulting in large total pressure loss in the combustion chamber.

### SUMMARY

In view of the above, the application provides an anti-back-transfer intake structure for a rotating detonation combustion chamber, which adopts the following technical solution: an anti-back-transfer intake structure for a rotating detonation combustion chamber including a Tesla valve communicating with the rotating detonation combustion chamber and arranged at an inlet of the rotating detonation combustion chamber. The Tesla valve includes a casing and a flow passage, the casing is coaxially connected with an outer wall of the rotating detonation combustion chamber, and the flow passage is arranged in the casing. The flow passage has an inlet end configured for introducing air, and an outlet end communicating with an annular passage of the rotating detonation combustion chamber; and

the inlet end and the outlet end of the flow passage are both provided with pressure regulating structures, each of the pressure regulating structures includes an air collection chamber and an air inlet hole configured for connecting the air collection chamber with the flow passage, a radial outside of the flow passage is configured with an ejector passage, an outlet of the ejector passage is in communication with an outlet of the rotating detonation combustion chamber, the outlet of the ejector passage faces away from the inlet end of the flow passage, and the ejector passage is in communication with the air collection chamber.

In the above technical solution, by using the one-way flow characteristics of the Tesla valve, a forward passage for guiding air and fuel into the rotating detonation combustion chamber is separated from a backward passage for back-transferring pressure and combustion product, so as to effectively reduce the possibility of back-transferred pressure and combustion product blocking air and fuel, so that the detonation pressurization can make up for the total pressure loss due to air intake. Thus, the total pressure gain of the rotating detonation combustion chamber is improved, and the high temperature returned by the combustion products is avoided to ignite the reactants in advance, so as to reduce the influence of the back transferring of the combustion products on the performance of the rotating detonation combustion chamber. Further, the Tesla valve can realize the one-way flow of air flow without any moving parts and input energy. There is a large difference between a forward flow and a reverse flow, and thus there is no need for internal mechanical movement. It uses merely a spatial structure to promote the gas flow and a physical structure to accelerate the gas.

When the air is input through the air supply equipment such as a compressor and a turbine, the input air pressure is defined as the inflow pressure. However, after rotating detonation, if the air must be continuously input, the inflow pressure must be increased, that is, the output air pressure from the air supply equipment must be increased, which results in a mismatch between the former air supply equipment with original design parameters and the rotating detonation combustion chamber.

The pressure regulating structure is additionally provided at the outlet end of the flow passage, which means that an impedance wall is additionally provided at the outlet end of the flow passage. When the pressure wave generated due to rotating detonation is back-transferred to the outlet end of the flow passage, the back-transferred high-pressure air will enter the air collection chamber due to the bulk-cavity effect, such that it is only necessary to slightly increase or it is not necessary to adjust the inflow pressure, to meet the air supply demand, therefore, the air supply equipment can easily match the detonation combustion chamber directly.

When the rotating detonation occurs in the annular passage, due to the enormous pressure generated by the detonation wave, the explosive mixture in the annular passage with the same axial direction as the detonation wave and the high-pressure air are difficult to flow in the annular passage. The pressure regulating structure is additional provided at the inlet end of the flow passage, such that the high-pressure air enters the air collection chamber at the inlet end of the flow passage through the air inlet holes of the pressure regulating structure at the inlet end of the flow passage.

The high-pressure air in all air collection chambers flows into and ejected from the ejector passage, since the outlet of the ejector passage faces away from the inlet end of the flow passage, the high-pressure air ejected from the ejector passage can play a role of propulsion. Since the outlet of the ejector passage is in communication with the outlet of the rotating detonation combustion chamber, the pressure at the outlet of the rotating detonation combustion chamber can be decreased after the high-pressure air is ejected, thereby increasing the pressure difference between the inflow pressure and the pressure at the outlet of the rotating detonation combustion chamber. In this way, the inlet velocity of the annular passage can be increased, which on the one hand can improve the mixing effect of the air and the fuels, on the other hand is helpful for the explosive mixture of the air and the fuels to enter the annular passage to conduct rotating detonation, and furthermore, by which the air can continuously enter into the air collection chamber, so that the high-pressure air in the air collection chamber can be utilized, thereby improving the utilization rate of the high-pressure air.

Optionally, the flow passage comprises an air inlet passage, a connecting passage, an arc-shaped returning passage and an enlarged passage. One end of the air inlet passage is used to feed air, and the other end communicates with the connecting passage. The arc-shaped returning passage includes an arc-shaped passage and a straight passage. The straight passage is provided in linear communication with the connecting passage. The arc-shaped passage is configured to connect the straight passage to the air inlet passage. An included angle between the air inlet passage and the straight passage is an acute angle, and the enlarged passage is in linear communication with the connecting passage. A smaller end of the enlarged passage communicates with an end of the connecting passage away from the air inlet passage, and an larger end of the enlarged passage communicates with the annular passage of the rotating detonation combustion chamber.

In the above technical solution, when air and fuel enter the annular passage of the rotating detonation combustion chamber in a forward direction, the air and fuel enter the rotating detonation combustion chamber via the inlet passage, the connecting passage and the enlarged passage in turn. When a pressure wave and/or a combustion product generated in the rotating detonation combustion chamber are transferred backward, the pressure wave and/or combustion product pass through the enlarged passage, the connecting passage, the straight passage and the arc-shaped passage in turn. The straight passage and the arc-shaped passage form an arc-shaped returning passage. The pressure wave and/or combustion products are transferred backward through the arc-shaped returning passage, and are weakened by the arc-shaped returning passage. Since the returning passage of the pressure wave and combustion products and the forward inlet passage of air and fuel are different passages, returning pressure wave and/or combustion products have little impact on forward feeding of the air and fuel, so as to reduce the total inlet pressure loss, and increase the total pressure gain of the rotating detonation combustion chamber.

Optionally, the included angle between the air inlet passage and the straight passage is 30°-45°.

In the above technical solution, when the included angle between the air inlet passage and the straight passage is 30°-45°, the reverse blocking performance of Tesla valve is improved with the increase of the included angle.

Optionally, the casing comprises a first connecting cylinder, a second connecting cylinder and a guide block, the first connecting cylinder is coaxially sleeved with the second connecting cylinder, and the guide block is coaxially arranged between the first connecting cylinder and the second connecting cylinder. The first connecting cylinder includes a first connecting section, a second connecting section and a third connecting section connected in sequence, the second connecting cylinder includes a fourth connecting section, a fifth connecting section and a sixth connecting section connected in sequence, and the guide block includes a first straight guide surface, an arc-shaped guide surface and a second straight guide surface connected in sequence. One end of the first straight guide surface away from the arc-shaped guide surface is connected with one end of the second straight guide surface away from the arc-shaped guide surface. The second connecting section is parallel to the fifth connecting section. The connecting passage is positioned between the second connecting section and the fifth connecting section, the first connecting section and the third connecting section are positioned at both ends of the second connecting section and inclined towards a side away from the fifth connecting section. The sixth connecting section is symmetrical to the third connecting section, the enlarged passage is positioned between the third connecting section and the sixth connecting section, the fourth connecting section is arranged on a side of the fifth connecting section close to the first connecting section and at an end of the fifth connecting section away from the sixth connecting section, and the air inlet passage is positioned between the first connecting section and the first straight guide surface. The arc-shaped passage is positioned between the fourth connecting section and the arc-shaped guide surface, and the straight passage is positioned between the second straight guide surface and the fifth connecting section.

In the above technical solution, the first connecting section, the second connecting section and the third connecting section form a first connecting cylinder, the fourth connecting section, the fifth connecting section and the sixth connecting section form a second connecting cylinder, and the first straight guide surface, the arc-shaped guide surface and the second straight guide surface form the guide block, so as to form a flow passage, which has simple structure and is convenient for mass production.

Optionally, a casing is arranged on one side of the first connecting cylinder away from the second connecting cylinder, a containing cavity for containing fuel is formed between the casing and the first connecting cylinder, and a plurality of fuel ejection holes are arranged between the containing cavity and the air inlet passage.

In the above technical solution, the fuel is loaded in the containing cavity, and the fuel in the containing cavity is injected into the air inlet passage through the fuel ejection hole.

Optionally, the fuel ejection holes are circumferentially provided on the first connecting section at intervals and positioned on a side of the first connecting section close to the second connecting section.

In the above technical solution, the fuel ejected from the fuel ejection hole enters the second connecting section with the air, and the incoming air provides power for the flow of fuel.

Alternatively, a plurality of first connecting columns are arranged circumferentially on one side of the first straight guide surface close to the first connecting section, the other end of the first connecting column is connected with the first connecting section, a plurality of second connecting columns are arranged circumferentially on one side of the second straight guide surface close to the fifth connecting section, and the second connecting column is connected with the fifth connecting section.

In the above technical solution, the connection between the first connecting section and the first straight guide surface is realized through the first connecting column, and the connection between the fifth connecting section and the second straight guide surface is realized through the second connecting column, which is convenient for connecting and fixing the diversion block.

Optionally, the ejector passage includes an air outlet passage in communication with the outlet of the rotating detonation combustion chamber and a pressurization passage in communication with the air outlet passage, and a sectional area of the pressurization passage gradually decreases along an arrangement direction from the pressurization passage to the air outlet passage.

In the above technical solution, during the transportation process, the air in the ejector passage is transported to the air outlet passage through the pressurization passage, and finally is ejected from the air outlet passage. The sectional area of the pressurization passage gradually decreases along the arrangement direction from the pressurization passage to the air outlet passage, thereby increasing the flow rate of the air through the pressurization passage, so as to increase the flow rate of the air ejected from the outlet of the ejector passage. On the one hand, the propulsion effect can be enhanced, and on the other hand, the pressure difference between the inflow pressure and the pressure at the outlet of the rotating detonation combustion chamber can be increased, thereby further improving the mixing effect and the supply speed of the explosive mixture.

Optionally, a plurality of guiding vanes for pre-rotation of fuels are provided in the flow passage, and the plurality of guiding vanes are circumferentially arranged at intervals.

In the above technical solution, when the air is output, the air will rotate after it is guided by the guiding vanes, such that the explosive mixture of the fuels in the flow passage and the air is pre-rotated, so that the explosive mixture rotates into the annular passage. Such a provision is beneficial to modal control of the detonation wave.

Optionally, the plurality of fuel ejection holes are arranged in an axial direction of the first casing at intervals.

In the above technical solution, when high-pressure air is input through the flow passage in the axial direction of the casing, the fuels are ejected through the fuel ejection holes, which are arranged in the axial direction of the casing at intervals, so that the fuels are continuously injected during the transportation process of the high-pressure air. Compared with a single fuel ejection hole in the axial direction of the casing, the mixing time of the air and the fuels can be extended with the plurality of fuel ejection holes, so that the air and the fuels can be mixed and atomized better.

Optionally, an atomizing nozzle is provided at a side of a connection between the arc-shaped passage and the air inlet passage departing from the annular passage of the rotating detonation combustion chamber, and a proportion of the fuels in a mixture of the fuels and the air at the side of the connection between the arc-shaped passage and the air inlet passage departing from the annular passage of the rotating detonation combustion chamber is less than or equal to 20%.

In the above technical solution, after rotating detonation, the pressure wave and/or combustion products are back-transferred to the connection between the arc-shaped passage and the air inlet passage. If the proportion of the fuels in the mixture of the fuels and the air is greater than 20%, the air and the fuels are easy to burn directly at the above connection. By controlling the proportion of the fuel in the mixture of the fuels and the air below 20%, even if the fuels are ejected by the atomizing nozzles at the side of the connection between the arc-shaped passage and the air inlet passage departing from the annular passage of the rotating detonation combustion chamber, the mixture of the air and the fuels cannot burn. Further, the fuels are directly ejected at the side of the connection between the arc-shaped passage and the air inlet passage departing from the annular passage of the rotating detonation combustion chamber, which can extend the contract time and distance of the air and the fuels, thereby facilitating the atomizing of the fuel, and improving the following detonation effect.

In summary, the present application can achieve at least one of the following beneficial technical effects.
1. By using the one-way flow characteristics of the Tesla valve, a forward passage for guiding air and fuel into the rotating detonation combustion chamber is separated from a backward passage for back-transferring pressure and combustion product, so as to effectively reduce the possibility of back-transferred pressure and combustion product blocking air and fuel, so that the detonation pressurization can make up for the total pressure loss due to air intake. Thus, the total pressure gain of the rotating detonation combustion chamber is improved, and the high temperature returned by the combustion products is avoided to ignite the reactants in advance, so as to reduce the influence of the back transferring of the combustion products on the performance of the rotating detonation combustion chamber.
2. The use of the Tesla valve without moving parts can realize the one-way flow of air flow without any moving parts and input energy. There is a large difference between a forward flow and a reverse flow, and thus there is no need for internal mechanical movement. It uses merely a spatial structure to promote the gas flow and a physical structure to accelerate the gas;
3. When air and fuel enters the annular passage of the rotating detonation combustion chamber in a forward direction, the air and fuel enters the rotating detonation combustion chamber via the inlet passage, the connecting passage and the enlarged passage in turn. When a pressure wave and/or a combustion product generated in the rotating detonation combustion chamber are transferred backward, the pressure wave and/or combustion product pass through the enlarged passage, the connecting passage, the straight passage and the arc-shaped passage in turn. The straight passage and the arc-shaped passage form an arc-shaped returning passage. The pressure wave and/or combustion products are transferred backward through the arc-shaped returning passage, and are weakened by the arc-shaped returning passage. Since the returning passage of the pressure wave and combustion products and the forward inlet passage of air and fuel are different passages, returning pressure wave and/or combustion products have little impact on forward feeding of the air and fuel, so as to reduce the total inlet pressure loss, and increase the total pressure gain of the rotating detonation combustion chamber.

### BRIEF DESCRIPTION OF THE DRAWINGS

FIG. 1 is a cross-sectional view of an intake structure of a rotating detonation combustion chamber in the related technology in use state;

FIG. 2 is a cross-sectional view of an anti-back-transfer intake structure of the rotating detonation combustion chamber according to Embodiment 1 of the present application in use state;

FIG. 3 is a partial structural diagram of FIG. 2;

FIG. 4 is a schematic diagram of the overall structure of a Tesla valve in FIG. 2;

FIG. 5 is a perspective sectional view of FIG. 4;

FIG. 6 is a partial structural diagram of FIG. 5;

FIG. 7 is an exploded view of FIG. 4 along an axial direction;

FIG. 8 is a cross-sectional view of an anti-back-transfer intake structure of a rotating detonation combustion chamber according to Embodiment 2 of the present application in use state; and

FIG. 9 is a partial structural diagram of FIG. 8.

FIG. 10 is a perspective view of Embodiment 3 of the present application after being cut away;

FIG. 11 is an enlarged schematic view of portion A in FIG. 10;

FIG. 12 is a structural diagram illustrating guiding vanes in Embodiment 3 of the present application;

FIG. 13 is a structural diagram illustrating atomizing nozzles in Embodiment 3 of the present application.

### DETAILED DESCRIPTION

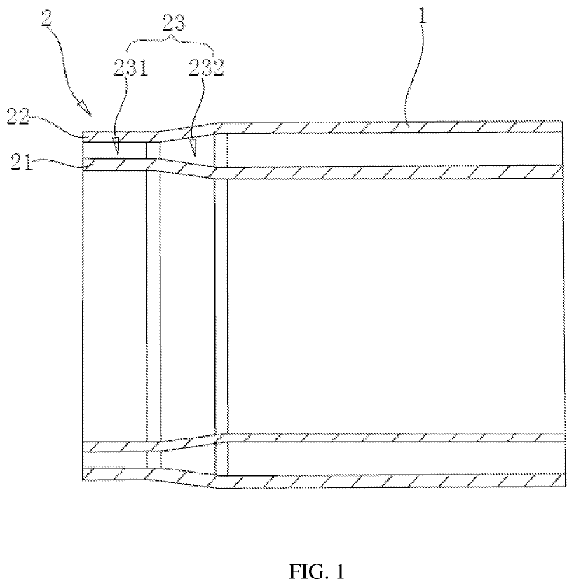

The present application will be further described in detail below in combination with FIGS. 1-9.

As shown in FIG. 1, an intake structure for a rotating detonation combustion chamber in the related technology includes an air inlet end 2 communicating with a combustion chamber body 1 and fixedly assembled at an inlet of the combustion chamber body 1. The air inlet end 2 includes coaxially sleeved inner wall 21 and an outer wall 22. Between the inner wall 21 and the outer wall 22, there is an air inlet passage 23 for fuel and air to enter the combustion chamber body 1. The air inlet passage 23 includes a connected straight passage 231 and an enlarged passage 232. One end of the straight passage 231 is connected with the outside air, the other end is connected with the enlarged passage 232, and the other end of the enlarged passage 232 is connected with the combustion chamber body 1. Therefore, a converging-enlarging inlet structure is formed.

Detonation wave is a chemical reaction zone caused by a shock wave, which rotates at a high speed around the combustion chamber body. The pressure at the location where the detonation wave is positioned is very high. Every time the detonation wave turns to a position, it will induce back transferring of a pressure, which will lead to the air inlet blockage of the air inlet end 2. After the blockage, the pressure attenuation is relatively slow, resulting in a long recovery time of the air inlet. When the detonation wave turns back to the original position again, fresh air and the fuel required for the reaction cannot be replenished into the combustion chamber body 1 in time, resulting in the extinction of the detonation wave.

The converging-enlarging intake scheme is essentially a supersonic intake scheme. A forward shock wave will be formed in the enlarged passage 232. This forward shock wave can block the pressure return of the detonation wave, and the Mach number of supersonic intake is very high, which can quickly supplement fresh air and fuel required for reaction. This solves the problem of slow intake recovery time, but the total pressure loss of the engine before and after the forward shock wave is large, and the rotary detonation wave cannot make up for the total pressure loss, resulting in a backward total pressure gain of a whole engine.

The combustion product is high-temperature exhaust gas that has been combusted. When the high-temperature exhaust gas in the combustion chamber body 1 is accumulated upstream of the air inlet passage 23, the reactants that would have been subject to detonation combustion upstream will be consumed in advance, in which the combustion mode is isobaric combustion of the conventional engine, so that the effective fuel is consumed by isobaric combustion, and pressurization cannot be realized.

The embodiments of the application disclose an anti-back-transfer intake structure for a rotating detonation combustion chamber.

### Embodiment 1

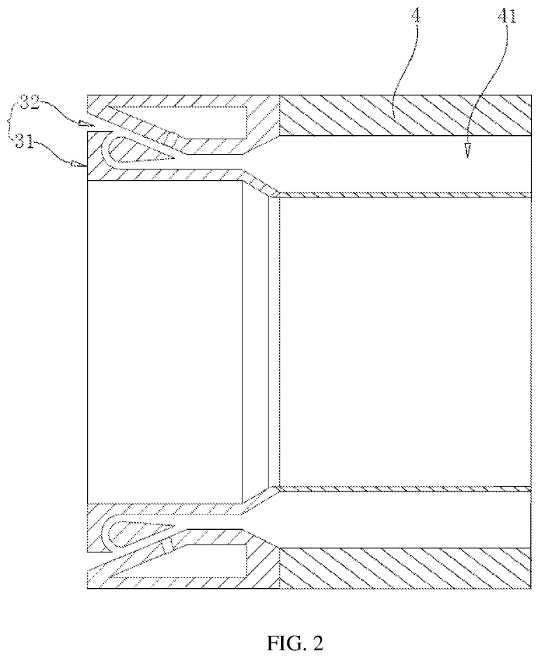

As shown in FIG. 2, an anti-back-transfer intake structure for a rotating detonation combustion chamber includes a Tesla valve 3 communicating with the rotating detonation combustion chamber 4 and snap connected in an inlet of the rotating detonation combustion chamber 4. The Tesla valve 3 includes a casing 31 and a flow passage 32. The casing 31 is coaxially snap connected with an outer wall of the rotating detonation combustion chamber 4. The flow passage 32 is opened in the casing 31. An inlet end of the flow passage 32 is used to feed air, and an outlet end of the flow passage 32 is connected with an annular passage 41 of the rotating detonation combustion chamber 4.

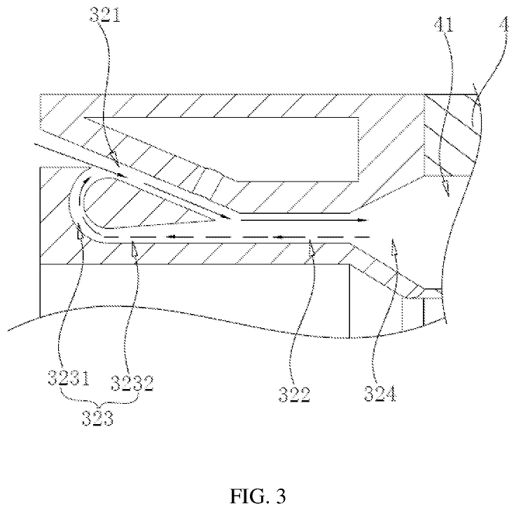

As shown in FIG. 2 and FIG. 3, the flow passage 32 includes an air inlet passage 321, a connecting passage 322, an arc-shaped returning passage 323 and an enlarged passage 324. One end of the air inlet passage 321 is configured to feed air, and the other end is connected with the connecting passage 322. The arc-shaped returning passage 323 includes an arc-shaped passage 3231 and a straight passage 3232. The straight passage 3232 is arranged in linear communication with the connecting passage 322. The arc-shaped passage 3231 is used to connect the straight passage 3232 to the air inlet passage 321. An included angle between the air inlet passage 321 and the straight passage 3232 is an acute angle, and the enlarged passage 324 is in linear communication with the connecting passage 322. A smaller end of the enlarged passage 324 is connected with an end of the connecting passage 322 away from the air inlet passage 321, and a larger end of the enlarged passage 324 is connected with the annular passage 41 of the rotating detonation combustion chamber 4.

As shown in FIG. 2 and FIG. 3, by using the one-way flow characteristics of the Tesla valve 3, a forward passage for guiding air and fuel into the rotating detonation combustion chamber is separated from a backward passage for back-transferring pressure and combustion product, so as to effectively reduce the possibility of back-transferred pressure and combustion product blocking air and fuel, so that the detonation pressurization can make up for the total pressure loss due to air intaking. Thus, the total pressure gain of the rotating detonation combustion chamber is improved, and the high temperature returned by the combustion products is avoided to ignite the reactants in advance, so as to reduce the influence of the back transferring of the combustion products on the performance of the rotating detonation combustion chamber 4.

Further, the use of the Tesla valve 3 can realize the one-way flow of air flow without any moving parts and input energy. There is a large difference between a forward flow and a reverse flow, and thus there is no need for internal mechanical movement. It uses merely a spatial structure to promote the gas flow and a physical structure to accelerate the gas.

Using the anti-back-transfer structure of the rotating detonation combustion chamber of the present application, when air and fuel enters the annular passage of the rotating detonation combustion chamber 4 in a forward direction, the air and fuel enters the rotating detonation combustion chamber 4 via the air inlet passage 321, the connecting passage 322 and the enlarged passage 324 in turn, and a pressure wave and/or a combustion product generated in the rotating detonation combustion chamber 4 pass through the enlarged passage 324, and the connecting passage 322, and are split by the arc-shaped passage 3231. when the pressure wave produced in the rotating detonation combustion chamber 4 is transferred backward through the arc-shaped returning passage, it passes through the enlarged passage 324 and the connecting passage 322, a bifurcation of the air inlet passage 321 and the straight passage 3232, the straight passage 3232 and the arc-shaped passage 3231 sequentially. The forward passage and the pressure wave returning passage of the air and fuel flow are different passages, and thus the possibility of back transferred pressure blocking the forward air and fuel can be effectively reduced, so that knock pressurization can make up for the loss of the total pressure. When the combustion products generated in the rotating detonation combustion chamber 4 are transferred backward, the combustion products are returned via the enlarged passage 324, the connecting passage 322, the straight passage 3232 and the arc-shaped passage 3231 in turn, which effectively reduces the possibility of fuel consumption due to a high temperature returned by the combustion products in advance. At the same time, the combustion products are cooled and diluted by fresh air fed through the inlet of the arc-shaped returning passage 323 and the air inlet passage 321, which reduces fuel consumption after reentering the air inlet passage 321.

As shown in FIG. 3, the included angle between the air inlet passage 321 and the straight passage 3232 is 30°-45°. With the increase of the included angle, the reverse blocking performance of Tesla valve 3 is improved, and when the included angle is 45°, the Tesla valve 3 has an optimal one-way flow performance. When the included angle is 30°-45°, the forward conduction performance of the Tesla valve 3 changes little, but when the included angle is greater than 60°, the forward conduction performance of the Tesla valve 3 is decreased sharply.

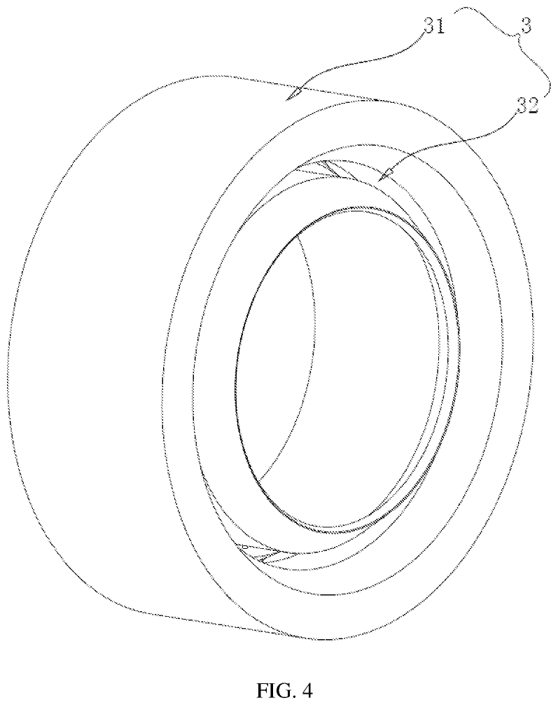

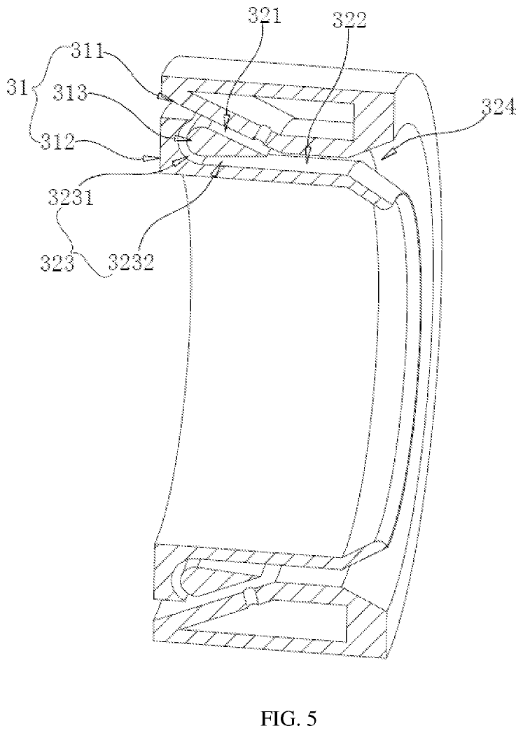

As shown in FIGS. 4 and 5, the casing 31 includes a first connecting cylinder 311, a second connecting cylinder 312 and a guide block 313. The first connecting cylinder 311 is coaxially sleeved outside the second connecting cylinder 312, and the guide block 313 is coaxially fixed between the first connecting cylinder 311 and the second connecting cylinder 312.

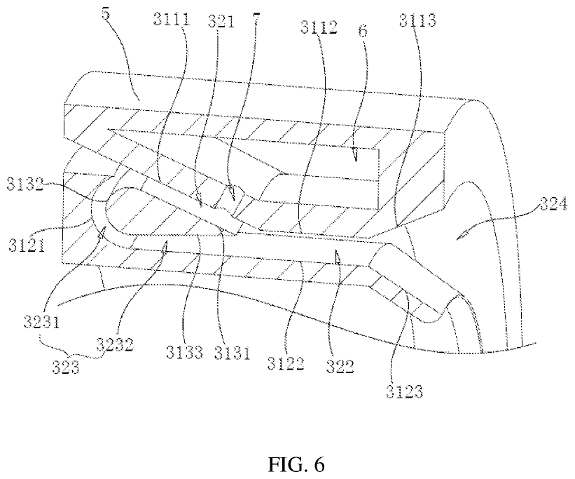

As shown in FIG. 5 and FIG. 6, the first connecting cylinder 311 includes a first connecting section 3111, a second connecting section 3112 and a third connecting section 3113 connected in sequence, and the first connecting section 3111, the second connecting section 3112 and the third connecting section 3113 are integrally formed. The second connecting cylinder 312 includes a fourth connecting section 3121, a fifth connecting section 3122 and a sixth connecting section 3123 connected in sequence, and the fourth connecting section 3121, the fifth connecting section 3122 and the sixth connecting section 3123 are integrally formed. The guide block 313 includes a first straight guide surface 3131, an arc-shaped guide surface 3132 and a second straight guide surface 3133 connected in sequence, and one end of the first straight guide surface 3131 away from the arc-shaped guide surface 3132 is connected with one end of the second straight guide surface 3133 away from the arc-shaped guide surface 3132. The second connecting section 3112 is parallel to the fifth connecting section 3122, the connecting passage 322 is positioned between the second connecting section 3112 and the fifth connecting section 3122, the first connecting section 3111 and the third connecting section 3113 are positioned at both ends of the second connecting section 3112 and inclined towards the side away from the fifth connecting section 3122, the sixth connecting section 3123 is symmetrical to the third connecting section 3113, and the enlarged passage 324 is positioned between the third connecting section 3113 and the sixth connecting section 3123. The fourth connecting section 3121 is arranged on a side of the fifth connecting section 3122 close to the first connecting section 3111 and at an end of the fifth connecting section 3122 away from the sixth connecting section 3123. The air inlet passage 321 is positioned between the first connecting section 3111 and the first straight guide surface 3131, the arc-shaped passage 3231 is positioned between the fourth connecting section 3121 and the arc-shaped guide surface 3132, and the straight passage 3232 is positioned between the second straight guide surface 3133 and the fifth connecting section 3122.

As shown in FIG. 6, a casing 5 is arranged on the side of the first connecting cylinder 311 away from the second connecting cylinder 312, and integrally formed with the first connecting cylinder 311. A containing cavity 6 for containing fuel is formed between the casing 5 and the first connecting cylinder 311, and a plurality of fuel ejection holes 7 are circumferentially arranged between the containing cavity 6 and the air inlet passage 321 at intervals. The fuel ejection holes 7 are arranged circumferentially on the first connecting section 3111 at equal intervals, and positioned on a side of the first connecting section 3111 close to the second connecting section 3112. The fuel is loaded in the containing cavity 6, and injected into the air inlet passage 321 through the fuel ejection hole 7. The fuel ejection hole 7 is closer to the connecting passage 322 than an air inlet into the air inlet passage 321, that is, the fuel ejected from the fuel ejection hole 7 enters the second connecting section 3112 with the air, and the incoming air provides power for the flow of fuel.

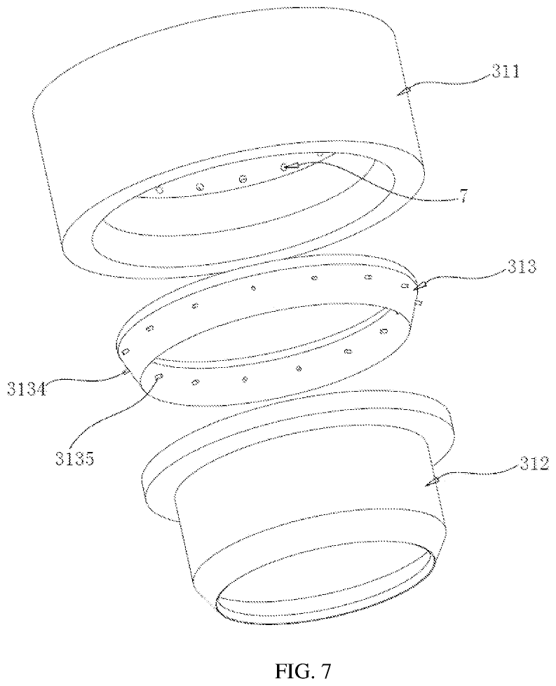

As shown in FIGS. 6 and 7, a plurality of first connecting columns 3134 are installed circumferentially at equal intervals on one side of the first straight guide surface 3131 close to the first connecting section 3111, the other end of the first connecting column 3134 is connected with the first connecting section 3111, a plurality of second connecting columns 3135 are installed circumferentially at equal intervals on one side of the second straight guide surface 3133 close to the fifth connecting section 3122, and the second connecting column 3135 is connected with the fifth connecting section 3122.

The implementation principle of Embodiment 1 of the application is as follows. When the air and fuel enter the rotating detonation combustion chamber 4 in a forward direction, the air and fuel enter the rotating detonation combustion chamber 4 via the air inlet passage 321, the connecting passage 322 and the enlarged passage 324 in turn.

When the pressure wave generated in the rotating detonation combustion chamber 4 are transferred backward, the pressure wave will pass through the enlarged passage 324 and the connecting passage 322 in turn, reach the bifurcation of the air inlet passage 321 and the straight passage 3232, and then the pressure wave will go straight through the straight passage 3232 and returned via the arc-shaped passage 3231.

When the combustion products generated in the rotating detonation combustion chamber 4 are transferred backward, the combustion products are returned through the enlarged passage 324, the connecting passage 322, the straight passage 3232 and the arc-shaped passage 3231 in turn.

### Embodiment 2

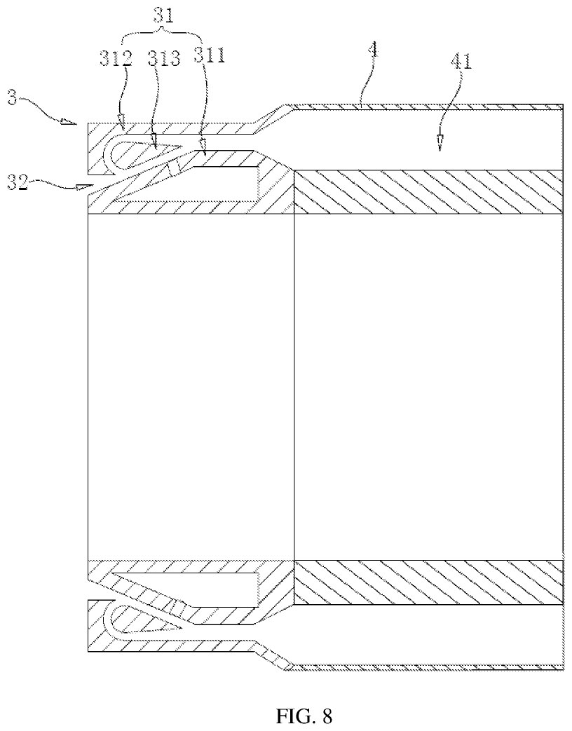

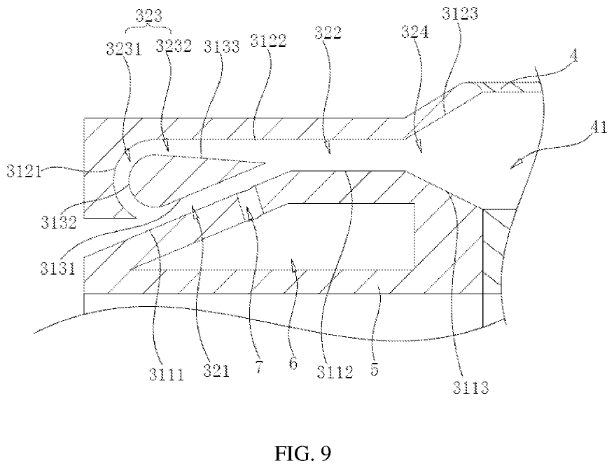

As shown in FIG. 8 and FIG. 9, the difference of this embodiment from Embodiment 1 is that, the casing 31 includes a first connecting cylinder 311, a second connecting cylinder 312 and a guide block 313. The first connecting cylinder 311 is coaxially sleeved inside the second connecting cylinder 312, and the guide block 313 is coaxially fixed between the first connecting cylinder 311 and the second connecting cylinder 312.

An implementation principle of Embodiment 2 is the same as that of Embodiment 1, which will not be repeated here.

### Embodiment 3

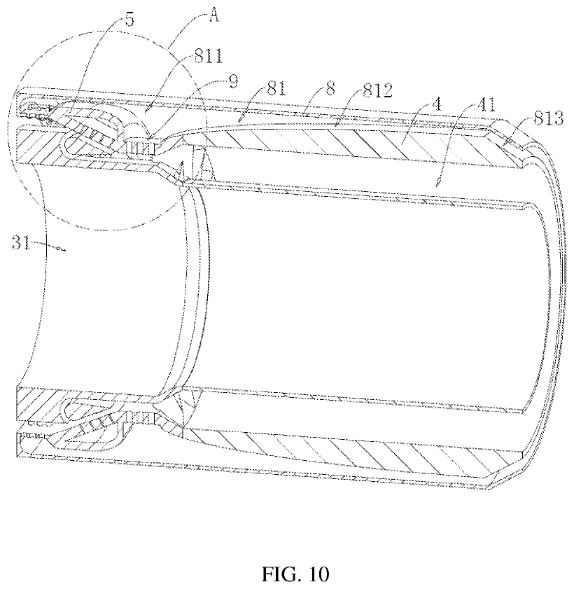

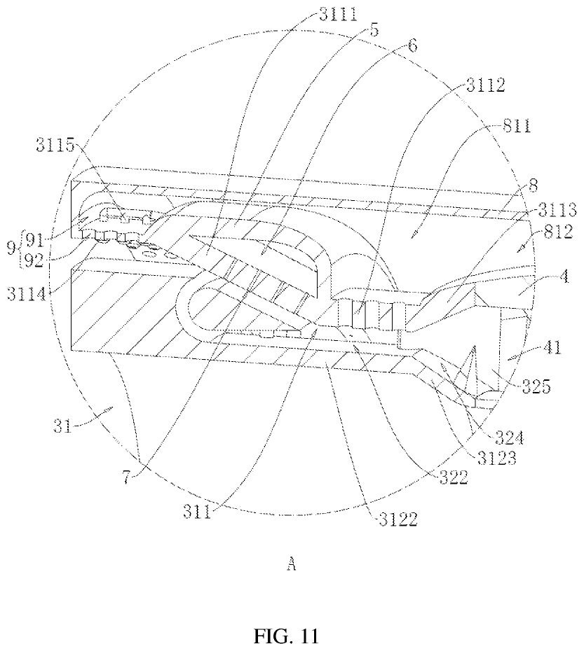

As shown in FIGS. 10-11, the difference of this embodiment from Embodiment 1 is that the first connecting cylinder 311 further includes an extension section 3114 fixed at an end of the first connecting section 3111 departing from the second connecting section 3112. The outside of the casing 5 is provided with a duct housing 8 sleeved over the first connecting cylinder 311, the casing 5 and the rotating detonation combustion chamber 4, and the duct housing 8 is fixedly connected to the extension section 3114. The containing cavity 6 is defined between the first connecting section 3111 and the casing 5. The second connecting section 3112 and the extension section 3114 are both provided with a plurality of pressure regulating structures 9. The plurality of pressure regulating structures 9 at the second connecting section 3112 and the plurality of pressure regulating structures 9 at the extension section 3114 are respectively circumferentially and uniformly arranged around the axis of the casing 31.

As shown in FIG. 11, the pressure regulating structure 9 includes an air collection chamber 91 and a plurality of air inlet holes 92 in communication with the air collection chamber 91, in particular, the air inlet holes 92 at the second connecting section 3112 are defined on the surface of the second connecting section 3112 facing the connecting passage 322. Three air inlet holes 92 at the second connecting section 3112 constitute a group, the air inlet holes 92 belonging to a same group are uniformly arranged in the axial direction of the casing 31, and the groups of air inlet holes 92 are circumferentially and uniformly arranged around the axis of the casing 31. The air collection chamber 91 of the pressure regulating structure 9 at the second connecting section 3112 is defined between the second connecting section 3112 and the duct housing 8, and the air inlet holes 92 are configured to connect the air collection chamber 91 at the second connecting section 3112 with the connecting passage 322.

As shown in FIG. 11, the air collection chamber 91 of the pressure regulating structure 9 at the extension section 3114 is defined between the extension section 3114 and the duct housing 8, and the air inlet holes 92 at the extension section 3114 are configured to connect the air inlet passage 23 at the extension section 3114 with the flow passage 32. Three air inlet holes 92 at the extension section 3114 constitute a group, the air inlet holes 92 belonging to a same group are arranged along the axial direction of the casing 31, and the groups of air inlet holes 92 are circumferentially and uniformly arranged around the axis of the casing 31. The second connecting section 3112 and the extension section 3114 form impedance walls due to the pressure regulating structures 9.

As shown in FIG. 10 and FIG. 11, an ejector passage 81 is defined between the duct housing 8 and the casing 5, the first connecting cylinder 311 and the rotating detonation combustion chamber 4. The ejector passage 81 includes an air collection passage 811, a pressurization passage 812 and an air outlet passage 813, which are successively arranged along an arrangement direction from the connecting passage 322 to the enlarged passage 324. Each of the air collection chambers 91 is in communication with the air collection passage 811, the pressurization passage 812 is configured for connecting the air collection passage 811 with the air outlet passage 813, and a sectional area of the pressurization passage 812 gradually decreases along an arrangement direction from the pressurization passage 812 to the air outlet passage 813. The outlet of the air outlet passage 813 faces away from the air collection passage 811, the air outlet passage 813 extends obliquely towards the outlet of the annular passage 41, and the outlet of the air outlet passage 813 is in communication with the outlet of the rotating detonation combustion chamber 4, namely the outlet of the annular passage 41.

As shown in FIGS. 10-11, when detonation wave is transferred backward, the high-pressure air will enter the air collection chamber 91 at the second connecting section 3112 through the air inlet holes 92 at the second connecting section 3112 and flow into the ejector passage 81. Due to the enormous pressure generated by the detonation wave, the forward air with the same axial direction as the detonation wave enters the air collection chamber 91 at the extension section 3114 through the air inlet holes 92 at the extension section 3114 and flows into the ejector passage 81. The air entering the ejector passage 81 is finally ejected from the air outlet passage 813.

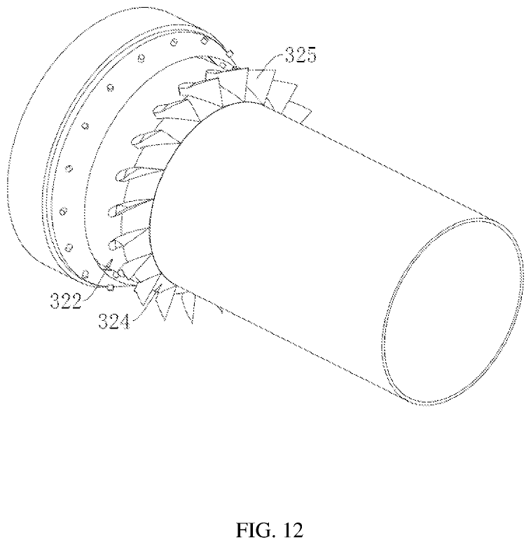

As shown in FIGS. 11-12, a plurality of guiding vanes 325 for pre-rotation of fuels are provided in the flow passage 32. The plurality of guiding vanes 325 are circumferentially arranged around the axis of the casing 31 at intervals, and located in the connecting passage 322 and the enlarged passage 324. The guiding vanes 325 are fixed on the second connecting section 3112, the third connecting section 3113, the fifth connecting section 3122 and the sixth connecting section 3123. Due to the guiding effect of the guiding vanes 325, the explosive mixture constituted by the fuels and the air instantly rotates when it enters the annular passage 41.

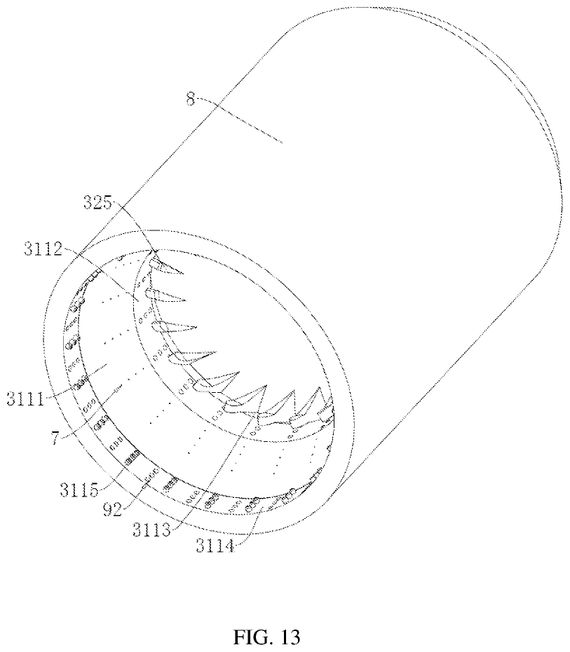

As shown in FIG. 11 and FIG. 13, a plurality of atomizing nozzles 3115 are provided at the extension section 3114, three atomizing nozzles 3115 constitute a group, and the atomizing nozzles 3115 belonging to a same group are uniformly arranged in the axial direction of the casing 31. The groups of atomizing nozzles 3115 are circumferentially and uniformly arranged around the axis of the casing 31, and the atomizing nozzles 3115 are in communication with the containing cavity 6 via tubes. The nozzle head of the atomizing nozzle 3115 is located at a side of the extension section 3114 facing the flow passage 32, and the atomizing nozzle 3115 is configured for ejecting and atomizing fuel. After the fuels ejected by the atomizing nozzles 3115 are mixed with the air to form the mixture, a proportion of the fuels in the mixture of the fuels and the air is less than or equal to 20%.

As shown in FIG. 11 and FIG. 13, several fuel ejection holes 7 constitute a group, the fuel ejection holes 7 belonging to a same group are uniformly arranged in the axial direction of the casing 31, and the groups of fuel ejection holes 7 are circumferentially and uniformly arranged around the axis of the casing 31. In this embodiment of the present application, four fuel ejection holes 7 constitute a group. Every time the mixture of the fuels and the air passes through one fuel ejection hole 7, the fuel concentration increases by 20% until it reaches 100%. In this embodiment of the present application, the fuel ejection hole 7 is configured as a very small hole, which can also be configured as an atomizing nozzle in another embodiments.

The implementation principle of Embodiment 3 of the present application is as follows. The influence of the detonation wave can be decreased by the pressure regulating structures 9 as much as possible, so that it is not necessary to adjust the inflow pressure or it is only necessary to slightly adjust it, which is conductive to the matching of the air supply equipment and the detonation combustion chamber. The high-pressure air back-transferred by the detonation wave and the input air, which cannot enter the flow passage 32 due to the influence of the detonation wave, flow into the ejector passage 81 through the pressure regulating structures 9 and are ejected from the ejector passage 81, thereby increasing the pushing force and increasing the pressure difference between the inflow pressure and the pressure at the outlet of the annular passage 41, which helps to mix the fuels and the air, and to continuously provide the explosive mixture.

The above are the preferred embodiments of the present application, which are not intended to limit the protection scope of the present application. Therefore, all equivalent changes made according to the structure, shape and principle of the present application should be covered within the protection scope of the present application.

What is claimed is:

1. An anti-back-transfer intake structure for a rotating detonation combustion chamber, comprising a Tesla valve communicating with the rotating detonation combustion chamber and arranged at an inlet of the rotating detonation combustion chamber, wherein the Tesla valve comprises a first casing and a flow passage, the first casing is coaxially connected with an outer wall of the rotating detonation combustion chamber, the flow passage is arranged in the first casing, and the flow passage has an inlet end for introducing air and an outlet end connected with an annular passage of the rotating detonation combustion chamber; and
the inlet end and the outlet end of the flow passage are both provided with pressure regulating structures, each of the pressure regulating structures comprises an air collection chamber and an air inlet hole configured for connecting the air collection chamber with the flow passage, a radial outside of the flow passage is configured with an ejector passage, an outlet of the ejector passage is in communication with an outlet of the rotating detonation combustion chamber, the outlet of the ejector passage faces away from the inlet end of the flow passage, and the ejector passage is in communication with the air collection chamber.

2. The anti-back-transfer intake structure for a rotating detonation combustion chamber according to claim 1, wherein the flow passage comprises an air inlet passage, a connecting passage, an arc-shaped returning passage and an enlarged passage, the air inlet passage has one end for introducing the air and a second end communicating with the connecting passage, the arc-shaped returning passage comprises an arc-shaped passage and a straight passage, the straight passage is arranged in linear communication with the connecting passage, the arc-shaped passage is configured to connect the straight passage with the air inlet passage, an included angle between the air inlet passage and the straight passage is an acute angle, the enlarged passage is in linear communication with the connecting passage, a smaller end of the enlarged passage is connected with an end of the connecting passage away from the air inlet passage, and a larger end of the enlarged passage is connected with the annular passage of the rotating detonation combustion chamber.

3. The anti-back-transfer intake structure for a rotating detonation combustion chamber according to claim 2, wherein the included angle between the air inlet passage and the straight passage is 30°-45°.

4. The anti-back-transfer intake structure for a rotating detonation combustion chamber according to claim 3, wherein the first casing comprises a first connecting cylinder, a second connecting cylinder and a guide block, the first connecting cylinder is coaxially sleeved with the second connecting cylinder, the guide block is coaxially arranged between the first connecting cylinder and the second connecting cylinder, the first connecting cylinder comprises a first connecting section, a second connecting section and a third connecting section connected in sequence, the second connecting cylinder comprises a fourth connecting section, a fifth connecting section and a sixth connecting section, the guide block comprises a first straight guide surface, an arc-shaped guide surface and a second straight guide surface connected in sequence, one end of the first straight guide surface away from the arc-shaped guide surface is connected with one end of the second straight guide surface away from the arc-shaped guide surface, the second connecting section is parallel to the fifth connecting section, the connecting passage is positioned between the second connecting section and the fifth connecting section, the first connecting section and the third connecting section are positioned at both ends of the second connecting section and inclined towards a side away from the fifth connecting section, the sixth connecting section is symmetrical to the third connecting section, the enlarged passage is positioned between the third connecting section and the sixth connecting section, the fourth connecting section is arranged on one side of the fifth connecting section close to the first connecting section and positioned at one end of the fifth connecting section away from the sixth connecting section, the air inlet passage is positioned between the first connecting section and the first straight guide surface, the arc-shaped passage is positioned between the fourth connecting section and the arc-shaped guide surface, and the straight passage is positioned between the second straight guide surface and the fifth connecting section.

5. The anti-back-transfer intake structure for a rotating detonation combustion chamber according to claim 4, wherein a second casing is arranged on one side of the first connecting cylinder away from the second connecting cylinder, a containing cavity for containing fuel is formed between the second casing and the first connecting cylinder, and a plurality of fuel ejection holes are arranged between the containing cavity and the air inlet passage.

6. The anti-back-transfer intake structure for a rotating detonation combustion chamber according to claim 5, wherein the plurality of fuel ejection holes are arranged circumferentially in the first connecting section at intervals and are positioned on a side of the first connecting section close to the second connecting section.

7. The anti-back-transfer intake structure for a rotating detonation combustion chamber according to claim 4, wherein a plurality of first connecting columns are arranged circumferentially on one side of the first straight guide surface close to the first connecting section, an end of each of the plurality of first connecting columns is connected with the first connecting section, a plurality of second connecting columns are arranged circumferentially at intervals on one side of the second straight guide surface close to the fifth connecting section, and each of the plurality of second connecting columns is connected with the fifth connecting section.

8. The anti-back-transfer intake structure for a rotating detonation combustion chamber according to claim 1, wherein the ejector passage comprises an air outlet passage in communication with the outlet of the rotating detonation combustion chamber and a pressurization passage in communication with the air outlet passage, and a sectional area of the pressurization passage gradually decreases along an arrangement direction from the pressurization passage to the air outlet passage.

9. The anti-back-transfer intake structure for a rotating detonation combustion chamber according to claim 1, wherein a plurality of guiding vanes for pre-rotation of fuels are provided in the flow passage, and the plurality of guiding vanes are circumferentially arranged at intervals.

10. The anti-back-transfer intake structure for a rotating detonation combustion chamber according to claim 5, wherein the plurality of fuel ejection holes are arranged in an axial direction of the first casing at intervals.

11. The anti-back-transfer intake structure for a rotating detonation combustion chamber according to claim 5, wherein an atomizing nozzle is provided at a side of a connection between the arc-shaped passage and the air inlet passage departing from the annular passage of the rotating detonation combustion chamber, and a proportion of fuels in a mixture of the fuels and the air in the side of the connection between the arc-shaped passage and the air inlet passage departing from the annular passage of the rotating detonation combustion chamber is less than or equal to 20%.
